(19) United States
(12) Patent Application Publication
(10) Pub. No.: US 2007/0131782 A1
(43) Pub. Date: Jun. 14, 2007

(54) Vehicle position data enhanced solar sensing for vehicle HVAC applications

(76) Inventors: Lawrence P. Ziehr, Clarkston, MI (US); Mark D. Nemesh, Troy, MI (US); Todd M. Tumas, Taylor, MI (US)

Correspondence Address: LAURA C. HARGITT;General Motors Corporation, Legal Staff, Mail Code 482-C23-B21, P.O. Box 300, Detroit, MI, 48265-3000, US

(21) Appl. No.: 11/296,987

(22) Filed: Dec. 8, 2005

(51) Int. Cl. F24D 19/10; B60H 1/32; B60H 1/00

(52) U.S. Cl. 236/1 B; 62/133; 165/203

(57) ABSTRACT

A vehicle HVAC system as described herein obtains solar intensity data from an onboard solar sensor, along with current vehicle position data from a telematics system or a GPS system. The current vehicle position data is processed to determine the current sun position, which is used to provide a real-time and accurate estimate of the solar intensity in the vehicle interior. Vehicle configuration information, including position data related to light-obstructing features such as pillars, may also influence the solar intensity estimate. The solar intensity estimate can be utilized to control the operation of the vehicle HVAC system.

### TECHNICAL FIELD

The present invention generally relates to onboard solar sensing systems for vehicle applications, and more particularly relates to an onboard solar sensing system that leverages real-time vehicle position data to generate accurate solar sensing data for one or more vehicle cabin locations.

### BACKGROUND OF THE INVENTION

Solar intensity information can be very useful in vehicle climate control (i.e., HVAC) systems. Intelligent onboard HVAC systems can use solar intensity data to adjust the outlet vent air temperature in the vehicle cabin, to control the routing of air in the vehicle cabin, to adjust the air velocity exiting the outlet vents, and to calculate the interior temperature of the vehicle. Conventional HVAC systems may employ a solar sensor mounted on the vehicle instrument panel such that the solar sensor receives solar energy that passes through the windshield of the vehicle. Such prior art solar sensors are utilized to help determine the light intensity entering the vehicle cabin, which may impact the settings of the HVAC system. For example, for a given ambient outside air temperature the HVAC system might generate relatively cooler air if the passengers are in the direct path of sunlight, and relatively warmer air if the passengers are not in the direct path of sunlight.

Existing HVAC systems having solar sensing capabilities are limited in that they do not adequately compensate for features of the vehicle that represent obstructions to sunlight. For example, window pillars may block the direct path of sunlight from the sun to the solar sensor, depending upon the time of day and the current orientation of the vehicle. These obstructions make the solar intensity measurements inaccurate and, therefore, can lead to unbalanced cooling/heating of the vehicle. Moreover, existing HVAC systems having solar sensing capabilities can be limited in that they do not accurately determine the solar conditions for each individual passenger location. Consequently, a multiple zone vehicle HVAC system that uses conventional solar sensing techniques does not adjust the climate for each passenger location based upon the localized solar conditions, or the HVAC system may require multiple solar sensors or a more complex single-solar sensor assembly, which can sense solar intensity in different directions, for each temperature zone in the vehicle.

Accordingly, it is desirable to have a system and method for generating real-time, accurate solar load information for a vehicle. In addition, it is desirable to have a system and method for generating solar load information suitable for adjusting a vehicle HVAC system, where the adjustments can account for the real-time positioning of the sun relative to the vehicle location and heading, while compensating for any sunlight obstructions associated with the vehicle design. Furthermore, other desirable features and characteristics of the present invention will become apparent from the subsequent detailed description and the appended claims, taken in conjunction with the accompanying drawings and the foregoing technical field and background.

### SUMMARY OF THE INVENTION

An onboard system and method for generating solar load information for a vehicle is described herein. The system can be utilized to control the HVAC system for the vehicle. The system provides an accurate real-time estimation of the position of the sun relative to the current location and heading of the vehicle, and adjusts the HVAC system to compensate for the current solar intensity conditions in the vehicle. In practice, the system provides better climate control by considering the actual and real-time solar intensity experienced by the passengers.

The above and other aspects of the invention may be carried out in one form by a method for generating solar load information for a vehicle. The method involves: obtaining location data for the vehicle; obtaining current date/time data; resolving current sun position relative to the vehicle, based on the location data and the current date/time data, to generate sun correction data; obtaining solar intensity data from an onboard solar sensor; obtaining vehicle configuration data; and normalizing the solar intensity data based on the sun correction data and the vehicle configuration data, to generate at least one solar load value for the vehicle.

### DESCRIPTION OF THE DRAWINGS

The present invention will hereinafter be described in conjunction with the following drawing figures, wherein like numerals denote like elements, and

FIG. 1 is a top view diagram of a vehicle and different sun positions relative to the vehicle;

FIG. 2 is a schematic representation of a system for generating solar load information for a vehicle;

FIG. 3 is a diagram that illustrates vehicle heading;

FIG. 4 is a diagram that illustrates sun azimuth;

FIG. 5 is a diagram that illustrates sun zenith;

FIG. 6 is a flow chart of an HVAC control process according to an example embodiment of the invention; and

FIG. 7 is a cross-sectional view of a portion of a vehicle windshield and instrument panel.

### DESCRIPTION OF AN EXEMPLARY EMBODIMENT

The following detailed description is merely exemplary in nature and is not intended to limit the invention or the application and uses of the invention. Furthermore, there is no intention to be bound by any expressed or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that the present invention may be practiced in conjunction with any number of HVAC control protocols and that the HVAC system described herein is merely one exemplary application for the invention.

For the sake of brevity, conventional techniques related to solar sensors, temperature sensors, navigation, GPS systems, vehicle HVAC systems, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in a practical embodiment.

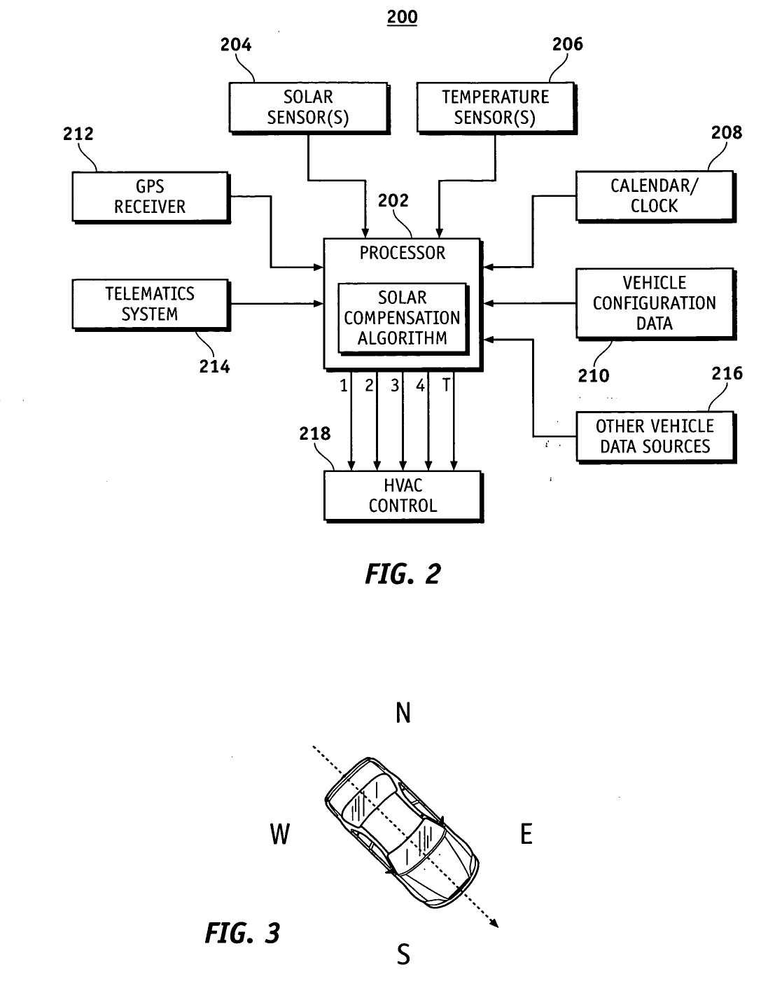

The following description refers to elements or features being “connected” or “coupled” together. As used herein, unless expressly stated otherwise, “connected” means that one element/feature is directly joined to (or directly communicates with) another element/feature, and not necessarily mechanically. Likewise, unless expressly stated otherwise, “coupled” means that one element/feature is directly or indirectly joined to (or directly or indirectly communicates with) another element/feature, and not necessarily mechanically. Thus, although the schematic shown in FIG. 2 depicts one example arrangement of elements, additional intervening elements, devices, features, or components may be present in an actual embodiment (assuming that the functionality of the system is not adversely affected).

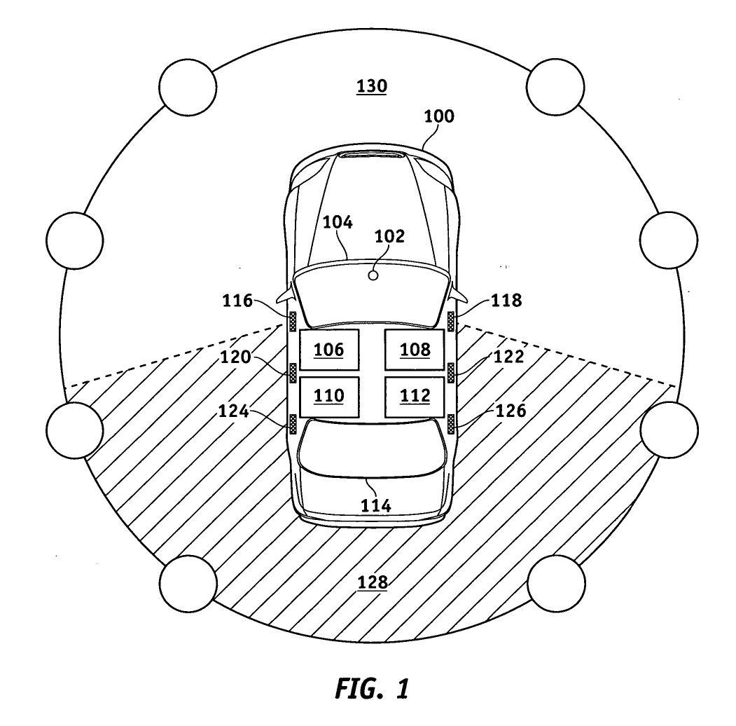

FIG. 1 is a top view diagram of a vehicle 100 and different sun positions relative to the vehicle. FIG. 1 depicts a typical operating environment for a system for generating solar load information as described in more detail below. Vehicle 100 includes a solar sensor 102, which is configured to obtain solar intensity data using known techniques. In this example, solar sensor 102 is mounted on the surface of the vehicle instrument panel in a position that is visible through the windshield 104 of vehicle 100. This particular vehicle 100 has four seats corresponding to four passenger locations: a front left (or driver) location 106; a front right location 108; a rear left location 110; and a rear right location 112. Vehicle may also include a rear window 114 and any number of side windows (not shown in FIG. 1).

Vehicle 100 may include one or more light-obstructing structures, where the number, size, shape, and location of the light-obstructing structures will vary depending upon the particular configuration, design, style, and/or platform of vehicle 100. As used herein, a “light-obstructing structure” is any feature, element, component, or element of a vehicle that can potentially obscure, block, or interfere with the direct path of sunlight that would otherwise directly reach an onboard solar sensor. In this regard, six light-obstructing structures are depicted in FIG. 1: a left front pillar 116; a right front pillar 118; a left middle pillar 120; a right middle pillar 122; a left rear pillar 124; and a right rear pillar 126. In practice, these pillars are structural features that support and/or define window borders of vehicle 100.

Depending upon the current location of vehicle 100, the current heading of vehicle 100 relative to true north, and the current position of the sun relative to vehicle 100, any of the light-obstructing structures (or any combination thereof) can block or interfere with the amount of direct sunlight reaching solar sensor 102. In the illustrated example where solar sensor 102 is mounted near the front of vehicle 100, the light-obstructing structures may block some of the sunlight when the sun is generally positioned within the dark zone shown in FIG. 1 (the dark zone is identified by reference number 128). In other words, dark zone 128 is associated with limited sensing capabilities in conventional systems. In contrast, the light-obstructing structures will have little or no impact on the path of sunlight when the sun is generally positioned within the light zone shown in FIG. 1 (the light zone is identified by reference number 130). Notably, prior art vehicle HVAC systems that depend upon solar sensor data may not function in an optimized manner when the sun is positioned within dark zone 128.

A system and method for generating solar load information for a vehicle as described herein addresses the limitations of prior art systems by deriving accurate solar intensity information based upon solar sensor (and/or temperature sensor) data, vehicle location information, and sun position information. The technique may be realized in the form of a processing algorithm that uses vehicle heading, time, date, vehicle location, and primitive solar sensor data to obtain high precision solar intensity data relative to the vehicle position and the sun position. The system achieves such precision by calculating sun azimuth angle and sun zenith angle, and resolving the data against the existing vehicle data. The calculated solar load data can correspond to the various vehicle seating positions, and a total or overall solar load value may also be calculated for general HVAC and other vehicle uses.

FIG. 2 is a schematic representation of a system 200 for generating solar load information for a vehicle. System 200 generally includes a processor architecture 202, at least one solar sensor 204 coupled to processor architecture 202, at least one temperature sensor 206 coupled to processor architecture 202, a calendar/clock 208 coupled to processor architecture 202, a vehicle configuration data source 210 coupled to processor architecture 202, and a location data source coupled to processor architecture 202. In practice, the location data source may be realized as an onboard GPS receiver 212 and/or an onboard telematics system 214. System 200 may also include one or more other vehicle data sources 216 coupled to processor architecture 202, and an HVAC control element 218 coupled to processor architecture 202. Processor architecture 202 may be coupled to the various features and components using suitable data communication links and suitable data communication protocols.

Processor architecture 202 may be implemented or performed with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. A processor may be realized as a microprocessor, a controller, a microcontroller, or a state machine. A processor may also be implemented as a combination of computing devices, e.g., a combination of a digital signal processor and a microprocessor, a plurality of microprocessors, one or more microprocessors in conjunction with a digital signal processor core, or any other such configuration.

In practice, processor architecture 202 is suitably configured to control the operation of system 200 and to perform the various tasks described herein. In addition, processor architecture 202 may be configured to control the operation of other features, systems, and/or components of the vehicle in which system 200 is deployed. Although not separately depicted in FIG. 2, processor architecture 202 may communicate with and/or include a suitable amount of memory, which may be realized with any processor-readable medium, including an electronic circuit, a semiconductor memory device, a ROM, a flash memory, an erasable ROM, a floppy diskette, a CD-ROM, an optical disk, a hard disk, an organic memory element, or the like. For example, vehicle configuration data source 210 may be implemented as a memory element that stores fixed vehicle configuration data.

For simplicity, the following description assumes that system 200 employs only one solar sensor 204. In practice, however, system 200 can utilize any number of solar sensors 204. Solar sensor 204 is configured to provide sensor data indicative of solar energy for a particular measurement location on the vehicle; solar sensor 204 provides sensor data in a suitable format that can be understood and processed by processor architecture 202. In this regard, solar sensor 204 is preferably mounted in a fixed position on or in the vehicle. For example, solar sensor 204 may be mounted on the instrument panel as depicted in FIG. 1. As explained in more detail below, solar sensor 204 need not be of high precision, and it need only provide an overall estimate of actual light intensity received at the measurement location.

In lieu of, or in addition to, solar sensor 204, system 200 may utilize temperature sensors 206 to obtain temperature data that is indicative of solar energy for a measurement location on the vehicle. Again, even though any number of temperature sensors 206 can be employed by a practical embodiment, the following description considers only one temperature sensor 206. Temperature sensor 206 is suitably configured to measure the local temperature at the measurement location. In practice, temperature sensor 206 may be realized as a thermistor, which can be mounted on the instrument panel, on the windshield, on the rear window, on the roof of the vehicle, on an external antenna of the vehicle, or the like. Temperature sensor 206 provides sensor data in a suitable format that can be understood and processed by processor architecture 202. As described in more detail below, system 200 processes the temperature data obtained from temperature sensor 206 and performs an energy balance to estimate the actual solar intensity at the measurement location. In other words, system 200 may be configured to derive the solar intensity information using temperature data rather than actual solar data.

Although not separately depicted in FIG. 2, temperature sensors 206 may include an outside air temperature sensor, a cabin air temperature sensor, and/or other vehicle temperature sensors. This additional temperature data can be utilized by system 200 to influence HVAC control element 218. Moreover, the additional temperature data may be utilized by other vehicle systems.

Calendar/clock 208 may be any suitable source that provides current date and time data to system 200. In practice, calendar/clock 208 may be implemented in GPS receiver and/or in telematics system 214. Alternatively, calendar/clock 208 may be realized in connection with any subsystem of the vehicle. Calendar/clock 208 provides date/time data to system 200 in a suitable format that can be understood and processed by processor architecture 202.

Vehicle configuration data source 210 may be any suitable source that provides vehicle configuration data to system 200. As explained above, vehicle configuration data source 210 may be realized as a memory element, e.g., RAM memory. The vehicle configuration data includes data indicative of the physical layout, design, and topology of the vehicle in which system 200 is deployed. In a practical embodiment, the vehicle configuration data may include data indicative of: the vehicle model; the vehicle make; the vehicle model year; the vehicle body dimensions; the locations of the vehicle windows; the locations of any light-obstructing structures; the glass type or composition of each window; glass thickness; locations of occupant seating surfaces; and any information necessary for the operation of system 200, such as the number of separate temperature-controlled zones in side of the vehicle. Vehicle configuration data source 210 provides the vehicle configuration data in a suitable format that can be understood and processed by processor architecture 202.

The location data source is suitably configured to provide current location data for the vehicle in which system 200 is deployed. The location data source provides the location data in a suitable format that can be understood and processed by processor architecture 202. In one practical embodiment, the location data source is telematics system 214. In this context, telematics system 214 is an onboard system that obtains various types of information from one or more data sources (which may be onboard or external sources) for processing, presentation to the operator, etc. For example, a practical telematics system may handle navigation data, ONSTAR system data, telephone data, satellite radio data, and/or satellite video data. Telematics system information may comprise or be derived from: GPS data; vehicle heading data; mapping software data; downloaded data; climate data; solar intensity data; ambient temperature data; weather data; or the like. In the context of system 200, telematics system 214 may provide the current vehicle location in terms of longitude and latitude measurements, the current vehicle heading in an absolute measurement (e.g., north, north-west, south-east, or the like), and/or the current vehicle angular heading relative to true north. FIG. 3 is a diagram that illustrates vehicle heading relative to the four primary directions. The dashed arrow indicates the direction of travel of the vehicle, and FIG. 3 depicts a south-east heading for the vehicle. Telematics system 214 may also provide system 200 with the current date, the current time, the current time zone, and other pertinent information.

In another practical embodiment, the location data source is GPS receiver 212, which may be a commercial civilian grade receiver. In accordance with known methodologies and techniques, GPS receiver 212 obtains GPS data corresponding to the GPS antenna location on the vehicle. The GPS data may indicate the current vehicle location in terms of longitude and latitude measurements, the current vehicle heading in an absolute measurement (e.g., north, north-west, south-east, or the like), and/or the current vehicle angular heading relative to true north. GPS receiver 212 may also provide system 200 with the current date, the current time, the current time zone, and other pertinent information. In practice, GPS receiver 212 may provide the GPS data to other onboard vehicle systems, such as a navigation system.

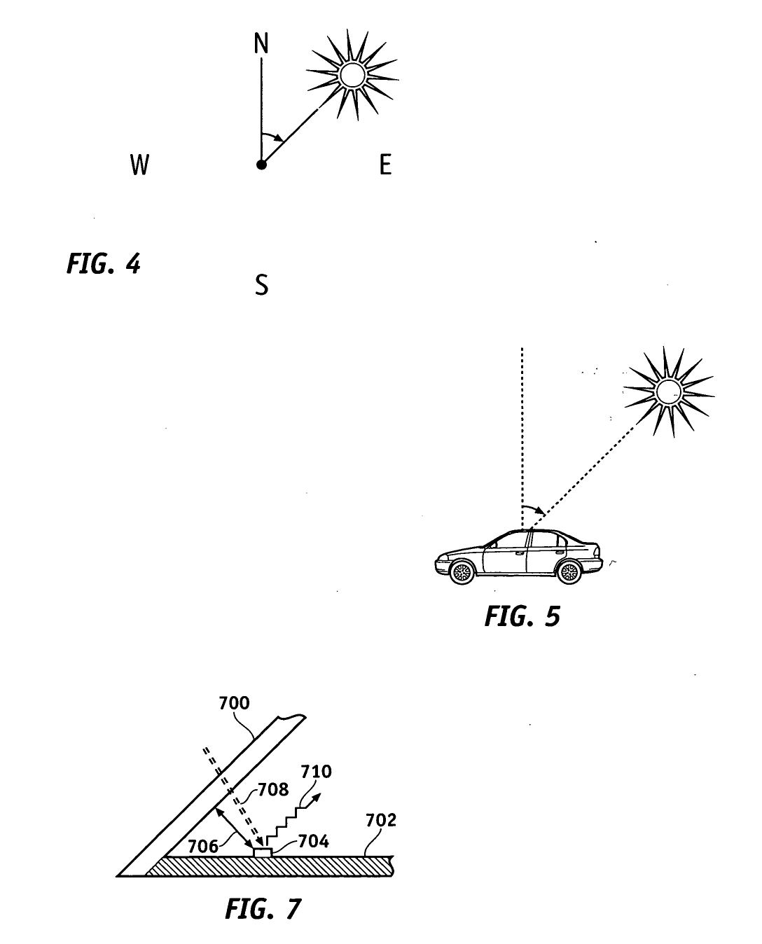

As described in more detail below, processor architecture 202 is generally configured to process the current location data for the vehicle, along with the current data/time data, to resolve the current sun position relative to the vehicle. For example, processor architecture 202 may calculate sun azimuth and/or sun zenith. In this regard, FIG. 4 is a diagram that illustrates sun azimuth as a clockwise angular measurement relative to true north, and FIG. 5 is a diagram that illustrates sun zenith as an angular measurement relative to a vertical axis. Moreover, processor architecture 202 may obtain or derive the time of sunrise and sunset for the current date. Resolving the sun position in this manner generates sun correction data that can be used by system 200 to better estimate the current solar intensity levels in the vehicle. Moreover, processor architecture 202 is suitably configured to process the sensor data (e.g., solar sensor data and/or temperature sensor data), the sun correction data, and the vehicle configuration data to generate at least one solar load value for the vehicle.

In this example, HVAC control element 218 is designed to accommodate zoned operation of an onboard HVAC system (not shown). In other words, the HVAC system has multiple zones that are independently controllable. In practice, a multi-zone vehicle HVAC system may have separate controls for different passenger seating locations. As depicted in FIG. 2, processor architecture 202 may generate four solar load values (labeled 1-4) corresponding to current solar intensity conditions at each of the four passenger seating locations of the vehicle. In addition, processor architecture 202 may generate a total or overall solar load value (labeled T) corresponding to a total solar intensity condition for the vehicle as a whole. These solar load values may be received as inputs to HVAC control element 218, which can then process the solar load values and adjust the operation of the HVAC system in an appropriate manner.

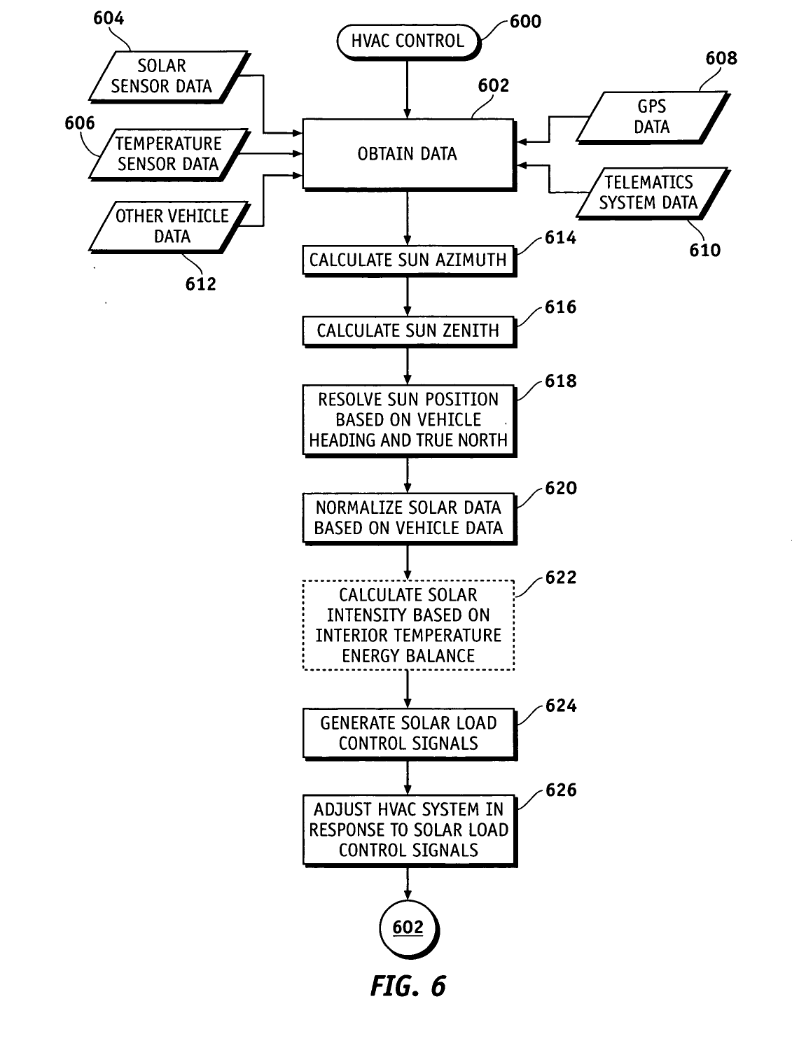

FIG. 6 is a flow chart of an HVAC control process 600 according to an example embodiment of the invention. Process 600 may be performed by an onboard system such as system 200. The various tasks performed in connection with process 600 may be performed by software, hardware, firmware, or any combination thereof. For illustrative purposes, the following description of process 600 may refer to elements mentioned above in connection with FIGS. 1-5. In practical embodiments, portions of process 600 may be performed by different elements of the described system, e.g., processor architecture 202, solar sensor 204, HVAC control element 218, or the like. It should be appreciated that process 600 may include any number of additional or alternative tasks, the tasks shown in FIG. 6 need not be performed in the illustrated order, and process 600 may be incorporated into a more comprehensive procedure or process having additional functionality not described in detail herein.

HVAC control process 600 begins by obtaining data (task 602) from one or more data sources. Such data may include, without limitation: solar intensity data 604 from one or more solar sensors; temperature data 606 from one or more temperature sensors; GPS data 608, which includes location data for the vehicle; telematics system data 610, which includes location data for the vehicle; and other vehicle data 612 (e.g., current date/time data, vehicle configuration data, onboard compass data, and vehicle velocity). Temperature data 606 may include the temperature of a measurement location on or in the vehicle, which is utilized for energy balancing as described below, the outside ambient air temperature, and/or the vehicle cabin air temperature.

HVAC control process 600 may calculate the sun azimuth angle (task 614) and the sun zenith angle (task 616) from the current date/time data and the current vehicle location data. In practice, process 600 may perform a “reverse sextant” technique to determine the azimuth and zenith angles. In addition, process 600 may resolve the current sun position relative to the vehicle (task 618) to generate sun correction data. In the example embodiment, process 600 resolves the current sun position against the current vehicle heading and true north, using the current vehicle location data, the current date/time, the sun azimuth angle, and the sun zenith angle. The resulting sun correction data enables the system to generate a real-time and accurate estimate of the actual solar intensity levels of the vehicle.

In one example embodiment, HVAC control process 600 normalizes the solar intensity data (task 620) based on the sun correction data and the vehicle configuration data. During task 620, process 600 compensates for the presence of any light-obstructing structures that may impact the solar intensity measured by the solar sensor(s). In other words, task 620 transforms the solar intensity data to produce accurate solar intensity estimates for one or more locations in the vehicle.

In an alternate embodiment, HVAC control process 600 calculates estimated solar intensity values based on the temperature data, the sun correction data, and the vehicle configuration data. In other words, process 600 derives solar intensity information from temperature data rather than calculating solar intensity information from a direct solar sensor measurement. In particular, process 600 may calculate the solar intensity based on an interior temperature energy balance technique (task 622, which is shown in dashed lines to indicate its optional nature). The energy balancing obtains an estimated solar intensity corresponding to the measurement location from which the temperature data was obtained. Notably, the energy balance and the estimated solar intensity may also be influenced by the measured inside air temperature of the vehicle, the measured outside ambient air temperature, the measured current velocity of the vehicle, and/or other conditions.

FIG. 7, which is a cross-sectional view of a portion of a vehicle windshield 700 and instrument panel 702, schematically depicts an example energy balance technique that may be performed during task 622. In this embodiment, a temperature sensor 704 measures the localized temperature at the measurement location on instrument panel 702. The energy balance estimates solar intensity at this measurement location by considering the radiation exchange 706 between windshield 700 and instrument panel 702, the transmitted solar energy 708 that passes through windshield 700, convection 710 from instrument panel 702 into the vehicle interior, and energy stored in temperature sensor 704 itself. One suitable energy balance relationship for this environment is as follows:

$${Q}_{solar} = \frac{1}{{K}_{sol\_abs}} \{ {K}_{RE} ( {T}_{IP} - {T}_{surr} ) + {H}_{A} ( {T}_{IP} - {T}_{air} ) - {K}_{s} \frac{ⅆ {T}_{IP}}{ⅆ t} \} ;$$

where

Kₛₒₗ_{_{—}}_{abs}=f(solar₁₃angle);

Tₛᵤᵣᵣ=f(T_{ambient}, vehicle₁₃ speed, Tₐᵢᵣ); and

H_{A}=f(air₁₃ delivery_method, HVAC_system_airflow)

Of course, the particular energy balance methodology may vary according to the specific system configuration and location of temperature sensor. For example, in lieu of a temperature sensor mounted to the vehicle instrument panel, the system may include a temperature sensor mounted directly to the windshield for measurement of the glass temperature. In this alternate embodiment, the solar intensity would be based on an energy balance around the measured glass temperature. As another example, in lieu of a temperature sensor mounted to the vehicle instrument panel, the system may include a temperature sensor mounted directly to the roof sheet metal for measurement of the inner surface temperature. In this alternate embodiment, the solar intensity would be based on an energy balance around the measured sheet metal temperature.

Whichever solar intensity estimation technique is employed, HVAC process 600 ultimately generates at least one solar load value for the vehicle (task 624). In the practical embodiment, these solar load values represent control signals for the vehicle HVAC system. In this regard, process 600 may adjust operation of the onboard HVAC system in response to the solar load values (task 626). For a multi-zone HVAC system, task 624 generates a plurality of positional solar load values for the vehicle (and possibly a total solar load value for the vehicle), where each positional solar load value corresponds to a particular passenger location of the vehicle. For such an embodiment, task 626 adjusts the zoned operation of the HVAC system in response to the individual positional solar load values (and possibly in response to a total solar load value). In a practical implementation, the solar load values can influence one or more functions of the HVAC system, including, without limitation: fan speed; output air temperature; airflow mode (e.g., upper vents, lower vents, defrost); selection of fresh versus recirculating air.

Following task 626, HVAC control process 600 can be re-entered at task 602, thus forming a continuous loop that represents an ongoing procedure. The technique described herein enables precise solar load estimation for the vehicle at all times regardless of vehicle location and regardless of the position of the sun relative to the vehicle. The HVAC system control technique can be utilized to provide solar compensation for multiple zones within the vehicle. Moreover, the control technique can provide sunrise and sunset correction, and solar filtering for tunnel, garage, and other covered environments.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

What is claimed is:

1. A method for generating solar load information for a vehicle, said method comprising:
obtaining location data for the vehicle;
obtaining current date/time data;
resolving current sun position relative to the vehicle, based on said location data and said current date/time data, to generate sun correction data;
obtaining solar intensity data from an onboard solar sensor;
obtaining vehicle configuration data; and
normalizing said solar intensity data based on said sun correction data and said vehicle configuration data, to generate at least one solar load value for the vehicle.

2. A method according to claim 1, further comprising adjusting, in response to said at least one solar load value, operation of an onboard HVAC system for the vehicle.

3. A method according to claim 1, wherein normalizing said solar intensity data generates a plurality of positional solar load values for the vehicle, each positional solar load value corresponding to a passenger location of the vehicle.

4. A method according to claim 3, further comprising adjusting, in response to said positional solar load values, zoned operation of an onboard HVAC system for the vehicle.

5. A method according to claim 1, wherein resolving current sun position comprises calculating sun azimuth and sun zenith.

6. A method according to claim 1, wherein:
said location data for the vehicle comprises data indicative of current vehicle heading; and
said sun correction data indicates current sun position relative to said current vehicle heading.

7. A method according to claim 1, wherein:
said vehicle configuration data comprises position data for light-obstructing structures of the vehicle; and
normalizing said solar intensity data compensates for said light-obstructing structures.

8. A method according to claim 1, wherein obtaining location data for the vehicle comprises receiving said location data from an onboard global positioning system receiver.

9. A method according to claim 1, wherein obtaining location data for the vehicle comprises receiving said location data from an onboard telematics system.

10. A method for generating solar load information for a vehicle, said method comprising:
obtaining location data for the vehicle;
obtaining current date/time data;
resolving current sun position relative to the vehicle, based on said location data and said current date/time data, to generate sun correction data;
obtaining temperature data for a measurement location on the vehicle;
obtaining vehicle configuration data; and
generating at least one solar load value for the vehicle, based upon said temperature data, said sun correction data, and said vehicle configuration data.

11. A method according to claim 10, wherein generating at least one solar load value comprises performing an energy balance to obtain an estimated solar intensity corresponding to said measurement location.

12. A method according to claim 11, further comprising obtaining inside air temperature for the vehicle, said inside air temperature influencing said energy balance and said estimated solar intensity.

13. A method according to claim 11, further comprising obtaining outside air temperature, said outside air temperature influencing said energy balance and said estimated solar intensity.

14. A method according to claim 11, further comprising obtaining a current velocity for the vehicle, said current velocity influencing said energy balance and said estimated solar intensity.

15. A method according to claim 10, further comprising adjusting, in response to said at least one solar load value, operation of an onboard HVAC system for the vehicle.

16. A method according to claim 10, wherein resolving current sun position comprises calculating sun azimuth and sun zenith.

17. A method according to claim 10, wherein:
said location data for the vehicle comprises data indicative of current vehicle heading; and
said sun correction data indicates current sun position relative to said current vehicle heading.

18. A method according to claim 10, wherein:
said vehicle configuration data comprises position data for light-obstructing structures of the vehicle; and
said at least one solar load value compensates for said light-obstructing structures.

19. A system for generating solar load information for a vehicle, said system comprising:
at least one sensor configured to provide sensor data indicative of solar energy for a measurement location on the vehicle;
a location data source configured to provide current location data for the vehicle;
a calendar-clock source configured to provide current date/time data;
a vehicle configuration data source configured to provide vehicle configuration data; and
a processor, coupled to said sensor, to said location data source, to said calendar-clock source, and to said vehicle configuration data source, said processor being configured to:
resolve current sun position relative to the vehicle, based on said current location data and said current date/time data, to generate sun correction data; and
generate at least one solar load value for the vehicle, based upon said sensor data, said sun correction data, and said vehicle configuration data.

20. A system according to claim 19, said at least one sensor comprising one or more of:
an onboard solar sensor;
an onboard temperature sensor.
